(19) United States
(12) Patent Application Publication
(10) Pub. No.: US 2019/0040923 A1
(43) Pub. Date: Feb. 7, 2019

(54) DAMPER AND OVERTURN PREVENTING DEVICE EQUIPPED WITH THE DAMPER

(71) Applicant: KYB CORPORATION, Minato-ku, Tokyo (JP)

(72) Inventors: Shinichi SEKINE, Minato-ku, Tokyo (JP); Akihisa OTA, Minato-ku, Tokyo (JP); Masaya UNE, Minato-ku, Tokyo (JP); Atsushi TOYOUCHI, Minato-ku, Tokyo (JP); Yukiko ISHIHARA, Minato-ku, Tokyo (JP); Chika IIDA, Minato-ku, Tokyo (JP)

(73) Assignee: KYB CORPORATION, Minato-ku, Tokyo (JP)

(21) Appl. No.: 16/074,898

(22) PCT Filed: Jan. 6, 2017
(86) PCT No.: PCT/JP2017/000241

§ 371 Date: Aug. 2, 2018

(30) Foreign Application Priority Data
Feb. 19, 2016 (JP) 2016-029567

(51) Int. Cl. F16F 9/088; A47B 97/00; A47B 96/14; F16F 15/023

(52) U.S. Cl. CPC F16F 9/088; A47B 97/00; F16F 9/067; F16F 15/023; A47B 96/14

(57) ABSTRACT

Providing a damper which exerts a damping force in an entire stroke range and an overturn preventing device which can successfully prevent an article from overturn by equipment of the damper. The damper includes a cylinder, a rod guide, a piston, a rod, and a cylindrical member. In the damper, a hydraulic fluid and a compressed gas are enclosed in the cylinder. The cylindrical member regulates a position of the piston so that the piston is immersed in the hydraulic fluid enclosed below the gas in a state where a bottom of the cylinder is located lower than an opening and the rod protrudes upward from the cylinder and where central axes of the cylinder and the rod are inclined at a predetermined angle with respect to a horizontal plane.

### TECHNICAL FIELD

The present invention relates to a damper and an overturn preventing device equipped with the damper.

### BACKGROUND ART

Patent Document 1 discloses an overturn preventing device equipped with a conventional damper, The damper includes a cylinder, a rod guide, a piston, and a rod. The cylinder is bottomed and is cylindrical in shape. The cylinder has an opening closed by the rod guide. The piston is slidably housed in the cylinder. The rod has a proximal end coupled to the piston and is slidably inserted through the rod guide, and a distal end side of the rod protrudes out of the cylinder. The damper encloses a hydraulic fluid. and a compressed gas in the cylinder. The damper constitutes an overturn preventing device to be mounted between a top surface of a piece of furniture and a ceiling. The overturn preventing device is mounted between the top surface of the furniture and the ceiling in a state where the bottom of the cylinder of the damper is located lower than the opening and where the rod protrudes upward from the cylinder and where central axes of the cylinder and the rod are inclined at a predetermined angle with respect to a horizontal plane. When the furniture is tilted by shaking of earthquake or the like, the piston of the damper is moved in the hydraulic fluid with the result that a damping force is generated. The damping force acts on the furniture to suppress the tilt of the furniture, whereby the furniture can be prevented from overturn.

### PRIOR ART DOCUMENT

### Patent Documents

Patent Document 1: Japanese Patent Application Publication No. JP 2015-6330

### SUMMARY OF THE INVENTION

### Problem to Be Overcome by the Invention

However, the piston of this damper has a possibility of being moved not only in the hydraulic fluid but also in the compressed gas enclosed above the hydraulic fluid in the cylinder.

When the piston is moved in the compressed gas, the damper cannot generate a damping force. In other words, this damper cannot generate the damping force in an entire stroke range.

Furthermore, when a space between the top surface of the furniture and the ceiling is wide, the overturn preventing device equipped with this damper has a possibility of being mounted between the top surface of the furniture and the ceiling while the piston is placed in the compressed gas enclosed above the hydraulic fluid. When the overturn preventing device is mounted with the piston being placed in the compressed gas and the furniture is tilted by shaking of earthquake or the like, no damping force is generated by the damper until the damper is contracted so that the piston is moved into the hydraulic fluid. Accordingly, this overturn preventing device has a possibility that the damping force of the damper does not act on the furniture effectively with the result that the furniture would be overturned.

The present invention was made in view of the above-described circumstances in the conventional art and has an object to provide a damper which can exert a damping force in an entire stroke range and an overturn preventing device which can successfully prevent an article from overturn by equipment of the damper.

### Means for Overcoming the Problem

A damper in accordance with the invention includes a cylinder, a rod guide, a piston, a rod, and a regulator. The cylinder is bottomed and is cylindrical in shape. The rod guide closes an opening of the cylinder. The piston is slidably housed in the cylinder. The rod has a proximal end coupled to the piston and slidably inserted through the rod guide, so that a distal end side of the rod protrudes out of the cylinder. In the damper, an operating liquid and a gas are enclosed in the cylinder. The regulator regulates a position of the piston so that the piston is immersed in the operating liquid enclosed below the gas in the cylinder in a state where a bottom of the cylinder is located lower than the opening and the rod protrudes upward from the cylinder and where central axes of the cylinder and the rod are inclined at a predetermined angle with respect to a horizontal plane.

Here, the predetermined angle is assumed to be an angle at which the damper is actually used, and ranges from 65° to 90°, for example.

In the damper in accordance with the invention, the cylinder may have an interior divided by the piston into a rod-side pressure chamber in which the proximal end of the rod is housed and a counter-rod-side pressure chamber. The regulator may be disposed between the piston and the rod guide in the rod-side pressure chamber and may have a predetermined length along a central axis of the rod.

In the damper in accordance with the invention, the regulator may be a bag in which a gas is filled in a compressed state and which is elastically deformable while maintaining a length thereof in a direction of the central axis of the rod.

In the damper in accordance with the invention, the regulator may be a protrusion which protrudes inward from an inner surface of the cylinder located nearer to the rod guide side than the piston and to which an outer peripheral edge of the piston is locked.

In the damper in accordance with the invention, the regulator may be an annular member which is fixed in the cylinder to be located nearer to the rod guide side than the piston and has an insertion hole formed in a center thereof through which the rod is inserted.

In the damper in accordance with the invention, the regulator may be a flange which. protrudes outward from an outer peripheral surface of the rod and is locked to a lateral face of the rod guide at the piston side.

An overturn preventing device in accordance with the invention includes the above-described damper. The damper is mounted between a ceiling and a top surface of an article installed on an installation surface in the state where the bottom of the cylinder is located lower than the opening and the rod Protrudes upward from the cylinder and where central axes of the cylinder and the rod are inclined at the predetermined angle with respect to the horizontal plane.

Here, the predetermined angle is from 65° to 85° at which angle the article can be successfully prevented from overturn. The article includes furniture, a plurality of beds connected to each other in the up-down direction, large sized televisions, refrigerators, book shelves, showcases, server racks, and the like all of which have a possibility of being overturned by shaking of earthquake or the like.

### BRIEF DESCRIPTION OF THE DRAWINGS

FIG. 1 is a side view of the. overturn preventing device of a first embodiment, mounted between a top surface of an article and the ceiling;

FIG. 2 is a front. view of the overturn preventing device of the first embodiment, mounted between the top surface of the article and the ceiling;

FIG. 3 is a sectional view of a damper equipped on the overturn preventing device of the first embodiment, illustrating an extended state;

FIG. 4 is a sectional view of a damper equipped on the overturn preventing device of the first embodiment, illustrating a contracted state;

FIG. 5 is a sectional view of a damper equipped on the overturn preventing device of a second embodiment, illustrating an extended state;

FIG. 6 is a sectional view of a damper equipped on the overturn preventing device of the second embodiment, illustrating a contracted state;

FIG. 7 is a sectional view of a damper equipped on the overturn preventing device of a third embodiment, illustrating an extended state;

FIG. 8 is a sectional view of a damper equipped on the overturn preventing device of a fourth embodiment, illustrating an extended state;

FIG. 9 is a sectional view of a damper equipped on the overturn preventing device of a fifth embodiment, illustrating an extended state; and

FIG. 10 is a sectional view of a damper equipped on the overturn preventing device of the fifth embodiment, illustrating a contracted state.

### BEST MODE FOR CARRYING OUT THE INVENTION

First to fifth embodiments of the overturn preventing device equipped with a damper, in accordance with the present invention will be described with reference to the drawings.

### First Embodiment

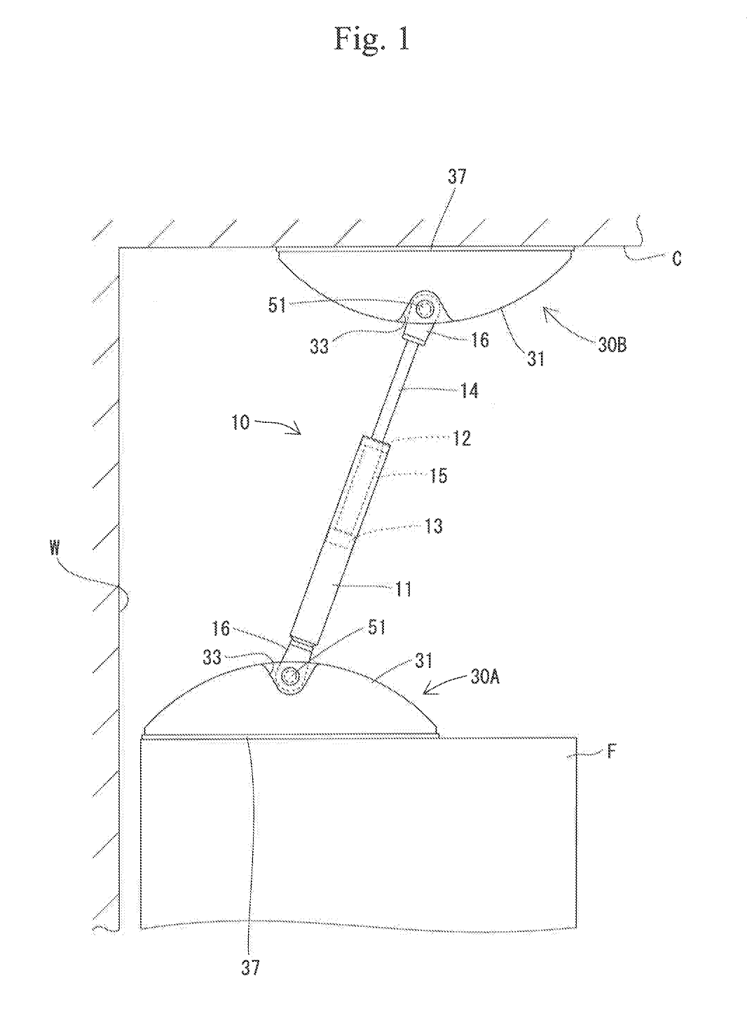

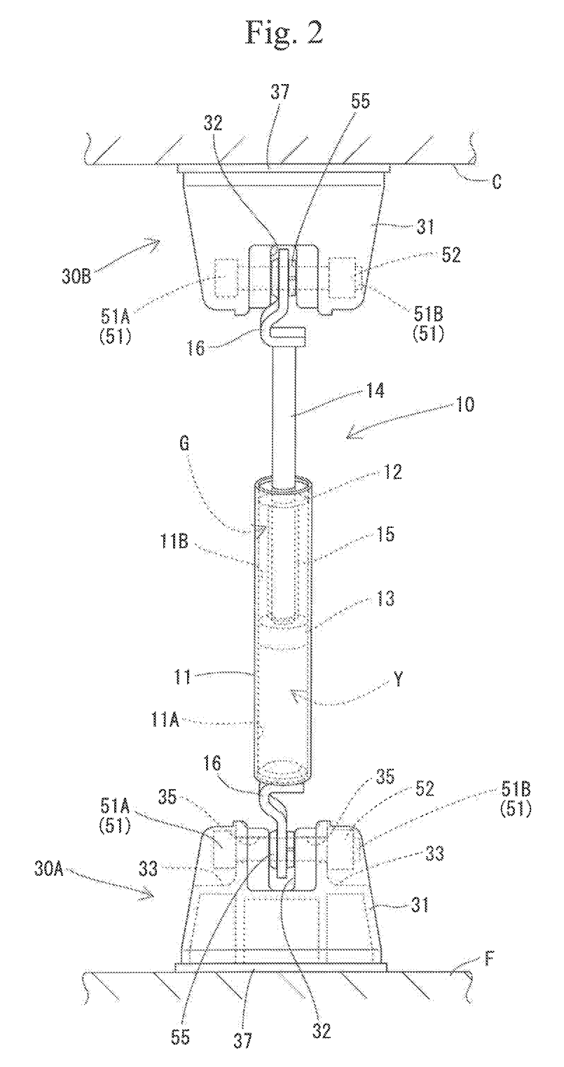

The overturn preventing device of a first embodiment includes a damper 10 and a pair of bases 30A and 30B, as illustrated in FIGS. 1 and 2. At least one overturn preventing device is mounted between a top surface of a piece of furniture F and a ceiling C. The furniture F is installed on a floor surface (not illustrated) with a back surface thereof being opposed to a wall surface W extending vertically from the floor surface. The furniture F is formed into rectangular parallelepiped shape and has a door, drawers (neither illustrated) and the like in the front (a right side as viewed in FIG. 1), so that clothes, accessories and the like can be housed in the furniture F. The furniture F has a rectangle-shaped horizontal section long in a right-left direction (a depthwise direction in FIG. 1). When the overturn preventing device 1 is not mounted on the furniture F, the furniture F would possibly be tilted frontward (rightward in FIG. 1) by shaking of earthquake or the like thereby to be overturned.

The damper 10 includes a cylinder 11, a rod guide 12, a piston 13, a rod 14, a cylindrical member 15 serving as a regulator, and two joints 16 respectively provided on two ends of the damper 10, as illustrated in FIGS. 1 to 4. The cylinder 11 is bottomed and formed into a cylindrical shape. The cylinder 11 has an opening closed by the rod guide 12. The piston 13 is slidably inserted into the cylinder 11. The rod 14 has a proximal end coupled to the piston 13. The rod 14 is further inserted through the rod guide 12, and a distal end side thereof protrudes out of the cylinder 11. An interior of the cylinder 11 is divided by the piston 13 into a rod-side pressure chamber 11B housing the proximal end of the rod 14 and a counter-rod-side pressure chamber 11A. In the damper 10, a predetermined amount of hydraulic fluid Y and a predetermined amount of compressed gas G are enclosed in the cylinder 11.

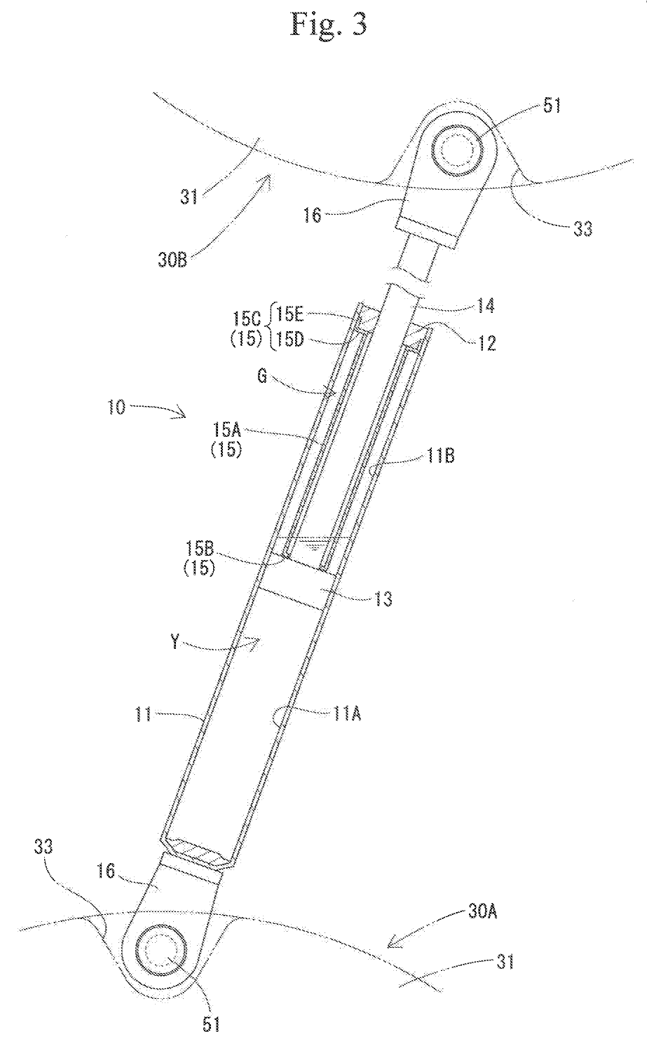

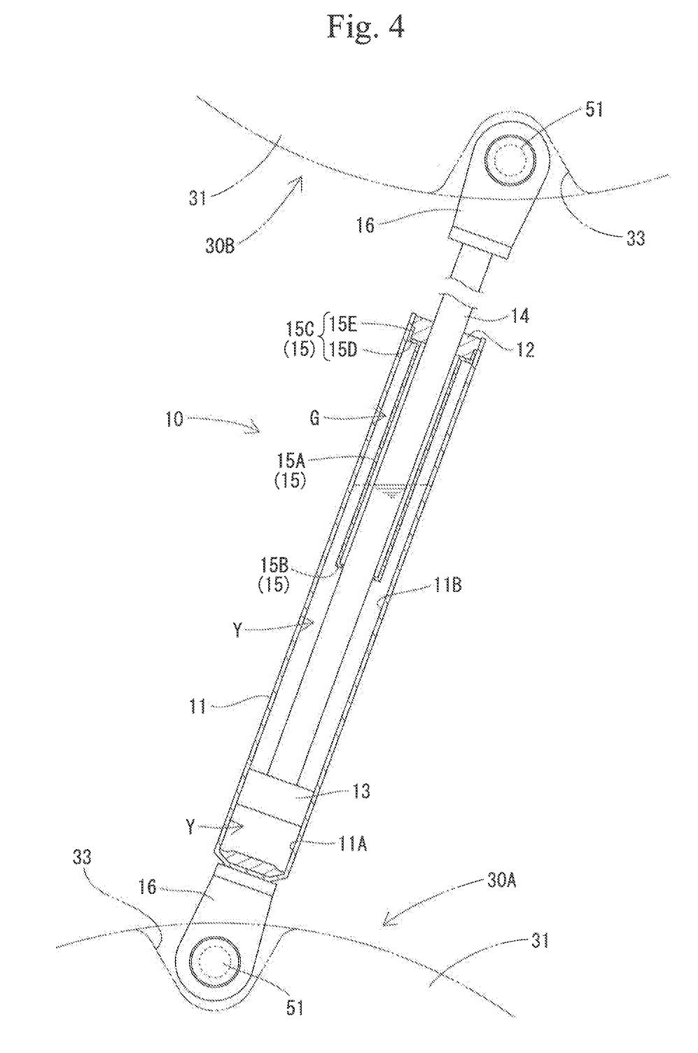

The cylindrical member 15 serving as the regulator is formed into a substantially cylindrical shape, as illustrated in FIGS. 3 and 4. The cylindrical member 15 includes a cylindrical part 15A, an abutting part 15B provided on one of two ends of the cylindrical part 15A, and a coupling part 15C provided on the other end of the cylindrical part 15A. The cylindrical part 15A has an inner diameter that is larger than an outer diameter of the rod 14. The abutting part 15B is formed by inwardly folding the one end of the cylindrical part 15A. The abutting part 15B formed into an annular shape and has an opening formed in a center thereof having an inner diameter that is slightly larger than an outer diameter of the rod 14. The coupling part 15C is formed by outwardly folding the other end of the cylindrical part 15A. The coupling part 15C includes an annular part 15D having an outer diameter that is substantially equal to an inner diameter of the cylinder 11, and a cylindrical sandwiched part 15E extending in a direction opposed to the cylindrical part 15A from an outer peripheral edge of the annular part 15D. The sandwiched part 15E of the cylindrical member 15 is sandwiched between an inner peripheral surface of the cylinder 11 and an outer peripheral surface of the rod guide 12 with the rod 14 being inserted through the cylindrical member 15, and is fixed in the cylinder 11. In other words, the cylindrical member 15 serving as the regulator is disposed between the piston 13 and the rod guide 12 in the rod-side pressure chamber 11E.

The overturn preventing device equipped with this damper 10 is mounted between the top surface of the furniture F and the ceiling C in a state where the bottom of the cylinder 11 is located lower than the opening of the cylinder 11, and where the rod 14 protrudes upward from the cylinder 11, and where central axes of the cylinder 11 and the rod 14 are inclined at an angle between 65° and 75° with respect to a horizontal plane, as will be described later. The cylindrical member 15 has a predetermined length along a central axis of the rod 14 and regulates the position of the piston 13 so that the piston is immersed in the hydraulic fluid Y enclosed below the compressed gas G in the state where the central axes of the cylinder 11 and the rod 14 are inclined at the angle between 65° and 75° with respect to the horizontal plane. In other words, when the piston 13 abuts against the abutting part 15B of the cylindrical member 15 interposed between the piston 13 and the rod guide 12, the piston 13 is not allowed to be further moved to the rod guide 12 side. Furthermore, the piston 13 in this damper 10 is in an immersed state in the hydraulic fluid Y when the piston 13 is in abutment against the abutting part 15B of the cylindrical member 15. As a result, the damper 10 can exert a damping force with the movement of the piston 13 in the hydraulic fluid Y in the entire stroke range.

The damper 10 is a compression damper in which a damping force generated during an extending operation is smaller than a damping force generated during a contracting operation. Here, the extending operation of the damper 10 refers to an operation which increases an amount of protrusion of the rod 14 out of the cylinder 11 and a length of the damper 10. The contracting operation of the damper 10 refers to an operation which reduces an amount of protrusion of the rod 14 out of the cylinder 11 and the length of the damper 10. In the damper 10, an expansion force of the compressed gas G enclosed in the cylinder 11 acts in an extension direction.

The following will describe a mechanism of generating a damping force by the damper 10. Since the mechanism has a known structure, diagrammatic representation is eliminated. The cylinder 10 has an interior divided by the piston 13 into a rod-side pressure chamber 11B in which the proximal end of the rod 14 is housed and a counter-rod-side pressure chamber 11A. The piston 13 is formed with an orifice communicating between both pressure chambers. The orifice functions as a damping force generator which applies resistance to a flow of the hydraulic fluid Y between the rod-side pressure chamber 11B and the counter-rod-side pressure chamber 11A with the extending/contracting operation of the damper 10. Furthermore, the piston 13 is formed with a communication path communicating via a check valve with both pressure chambers. The check valve allows the hydraulic fluid Y to flow from the rod-side pressure chamber 11B to the counter-rod-side pressure chamber 11A and blocks reverse flow of the hydraulic fluid. Accordingly, the damper 10 has two flow paths of the hydraulic fluid from the rod-side pressure chamber 11B to the counter-rod-side pressure chamber 11A during the extending operation, that is, one flow path including the orifice and the other flow path including the communication path. On the other hand, the damper 10 has only one flow path of the hydraulic fluid Y from the counter-rod-side pressure chamber 11A to the rod-side pressure chamber 11B through the orifice during the contracting operation. Accordingly, the damping force generated by the damper 10 during the extending operation is smaller than the damping force generated by the damper 10 during the contracting operation.

The joints 16 are each formed by bending a flat plate-shaped metal fitting as illustrated in FIGS. 1 to 4. The joints 16 are respectively connected to a bottom of the cylinder 11 and a distal end of the rod 14. Each joint 16 is formed with a through hole extending therethrough in a direction perpendicular to an axis line of the damper 10.

The paired bases 30A and 30B are respectively a first base 30A to which the joint 16 connected to the bottom of the cylinder 11 is coupled and a second base 30B to which the joint 16 connected to a distal end of the rod 14 is coupled, as illustrated in FIGS. 1 and 2. The first base 30A is placed in abutment on the top surface of the furniture F, and the second base 30B abuts against the ceiling C. The first and second bases 30A and 30B have the same form and the same structure. Each of the bases 30A and 30B includes a base body 31, a bolt 51 and a nut 52 serving as a rotating shaft member, a bush 55, and a slip preventing part 37.

The base body 31 has a rectangular outer shape in a planar view of the first base 30A as viewed from above in a state where the first base 30A placed in abutment on the top surface of the furniture F (hereinafter, a direction in which a long side in the outer shape of the base body 31 extends in this planar view will be referred to as “a long side direction” and a direction in which a short side extends will be referred to as “a short side direction”) Furthermore, in a side view of the first base 30A as viewed in the short side direction in the state where the first base 30A is placed in abutment on the top surface of the furniture F, the base body 31 has a lower edge which extends straightforward in parallel to the top surface of the furniture F and an upper edge which upwardly bulges from both sides of the lower edge thereby to have an arc-shaped outer shape (refer to FIG. 1) Still furthermore, in a side view of the first base 30A as viewed in the long side direction in the state where the first base 30A is placed in abutment on the top surface of the furniture F, the base body 31 has a trapezoidal outer shape in which the upper edge is shorter than the lower edge (refer to FIG. 2).

In the first base 30A placed in abutment on the top surface of the furniture F, the base body 31 had a groove 32 which is formed in an upper surface thereof and extends in the long side direction (a right-left direction as viewed in FIG. 1 and a depthwise direction as viewed in FIG. 2), as illustrated in FIG. 2.

In the first base 30A placed in abutment on the top surface of the furniture F, the base body 31 has recesses 33 respectively formed in both sides of the groove 32 in the middle in the long side direction, as illustrated in FIGS. 1 to 4. The recesses 33 are each open upward and outward with respect to the short side direction. The recesses 33 each have a side in which an insertion hole 35 which penetrates in the short side direction is open. A head 51A of the bolt 51 and the nut 52 screwed onto the bolt 51 which will be described later are respectively disposed in the recesses 33. The recesses 33 are formed to be upwardly spread in the long side direction so that tools can be fitted with the bolt head 51A and the nut 52 from above.

The rotating shaft member is composed of a bolt 51 inserted from one of the insertion holes 35 of the base body 31 and the nut 52 screwed onto a shaft part 51B of the bolt 51, as illustrated in FIG. 2. A central axis of the bolt 51 serves as a rotation axis of the damper 10 in each of the bases 30A and 30B.

The bushes 55 are respectively attached to the through holes formed in the joints 16 of the damper 10, as illustrated in FIG. 2. The bushes 55 are each rotatable about the shaft part 51B of the bolt 51. Furthermore, the bushes 55 are each inclinable relative to the shaft part 51B of the bolt 55. In other words, the damper 10 with the bushes 55 attached to the joints 16 is rotatable about the shaft parts 51B of the bolts 55 and swingable in a direction intersecting with the rotation direction.

The slip preventing part 37 has an outer shape that is similar to and slightly larger than an outer shape of the base body 31 (a rectangular shape), as illustrated in FIGS. 1 and 2. The preventing part 37 is made of an elastic material. In the first base 30A placed in abutment on the top surface of the furniture F, the preventing part 37 is fitted in a lower opening of the base body 31. Furthermore, the preventing part 37 is substantially flat in shape. In more detail, in the slip preventing part 37, a surface which abuts against the top surface of the furniture F or the ceiling C is flat. The preventing part 37 is detachably attached to the base body 31 by an elastic force thereof.

The overturn preventing device having the above-described construction is mounted between the top surface of the furniture F and the ceiling C so that the bottom of the cylinder 11 is located lower than the opening of the cylinder 11, so that the rod 14 protrudes upward from the cylinder 11, and so that the central axes of the cylinder 11 and the rod 14 are inclined at the angle between 65° and 75° with respect to the horizontal plane. When the overturn preventing device is thus mounted between the top surface of the furniture F and the ceiling C, the piston 13 of the damper 10 is put in a immersed state in the hydraulic fluid Y. Accordingly, when the furniture F is tilted by shaking of earthquake or the like, the damper 10 can exert a damping force in the entire stroke range so that the damping force of the damper 10 can always act on the furniture F, with the result that the furniture F can be prevented from overturn.

Accordingly, the overturn preventing device of the first embodiment can successfully prevent the furniture from overturn.

As described above, the damper 10 composing the overturn preventing device includes the cylinder 11, the rod guide 12, the piston 13, the rod 14 and the cylindrical member 15. The cylinder is bottomed and cylindrical in shape. The rod guide 12 closes the opening of the cylinder 11. The piston 13 is slidably housed in the cylinder 11. The rod 14 has the proximal end coupled to the piston 13 and slidably inserted through the rod guide 12, so that the distal end side thereof protrudes out of the cylinder 11. In the damper 10, the hydraulic fluid Y and the compressed gas G are enclosed in the cylinder 11. The cylindrical member 15 regulates the position of the piston 13 so that the piston 13 is immersed in the hydraulic fluid Y enclosed below the compressed gas G in the cylinder 11 in the state where the bottom of the cylinder 11 is located lower than the opening and where the rod 14 protrudes upward from the cylinder 11 and where central axes of the cylinder 11 and the rod 14 are inclined at the angle between 65° and 75° with respect to the horizontal plane.

In the damper 10, the position of the piston 13 is regulated so that the piston 13 is immersed in the hydraulic fluid Y enclosed below the compressed gas G in the state where the bottom of the cylinder 11 is located lower than the opening and where the rod 14 protrudes upward from the cylinder 11 and where the central axes of the cylinder 11 and the rod 14 are inclined at the angle between 65° and 75° with respect to the horizontal plane. In other words, the piston 13 is not moved into the compressed gas G enclosed to be located above the hydraulic fluid Y in the state where the damper 10 is inclined at the angle between 65° and 75° with respect to the horizontal plane. Consequently, when the damper 10 is extended or contracted, the piston 13 is always moved in the hydraulic fluid Y with the result that the damper 10 can exert a damping force.

Accordingly, the damper 10 of the first embodiment can exert a damping force in the entire stroke range.

Furthermore, the interior of the cylinder 11 is divided by the piston 13 into the rod-side pressure chamber 11B housing the proximal end of the rod 14 and the counter-rod-side pressure chamber 11A. The cylindrical member 15 is disposed between the piston 13 and the rod guide 12 in the rod-side pressure chamber 11A and has the predetermined length along the central axis of the rod 14. As a result, the cylindrical member 15 is interposed between the piston 13 and the rod guide 12 in this damper 10, and when the piston 13 abuts against the cylindrical member 15, further movement of the piston 13 to the rod guide 12 side is disallowed. In other words, the cylindrical member 15 regulates the position of the piston 13 while having a length such that the piston 13 is immersed in the hydraulic fluid Y. Consequently, the damper 10 can exert a damping force with the movement of the piston 13 in the hydraulic fluid Y in the entire stroke range.

### Second Embodiment

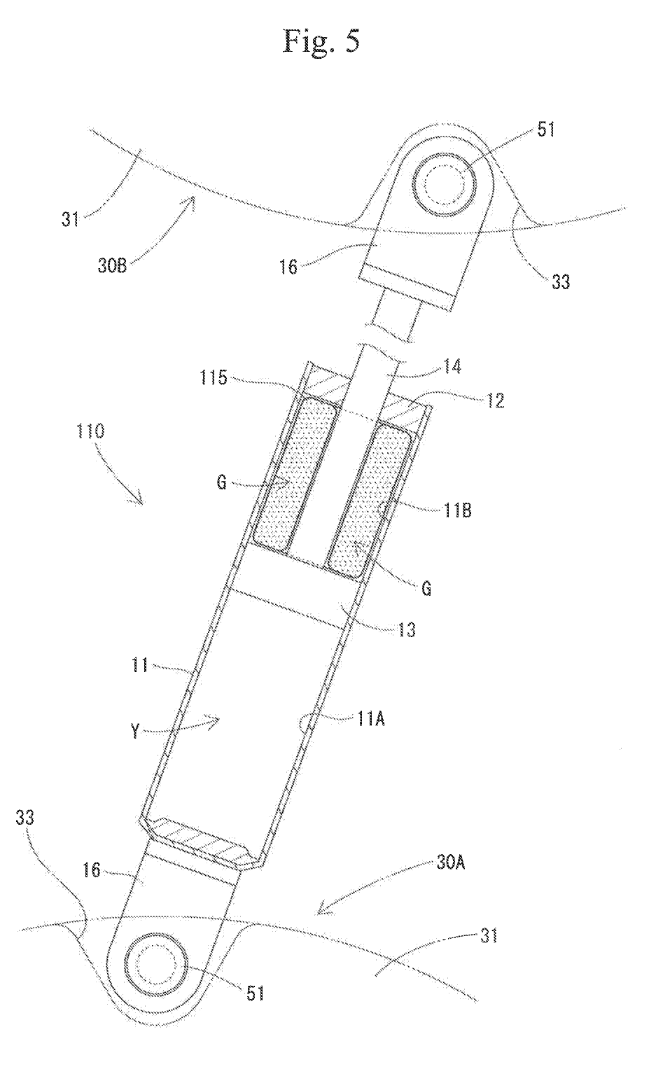

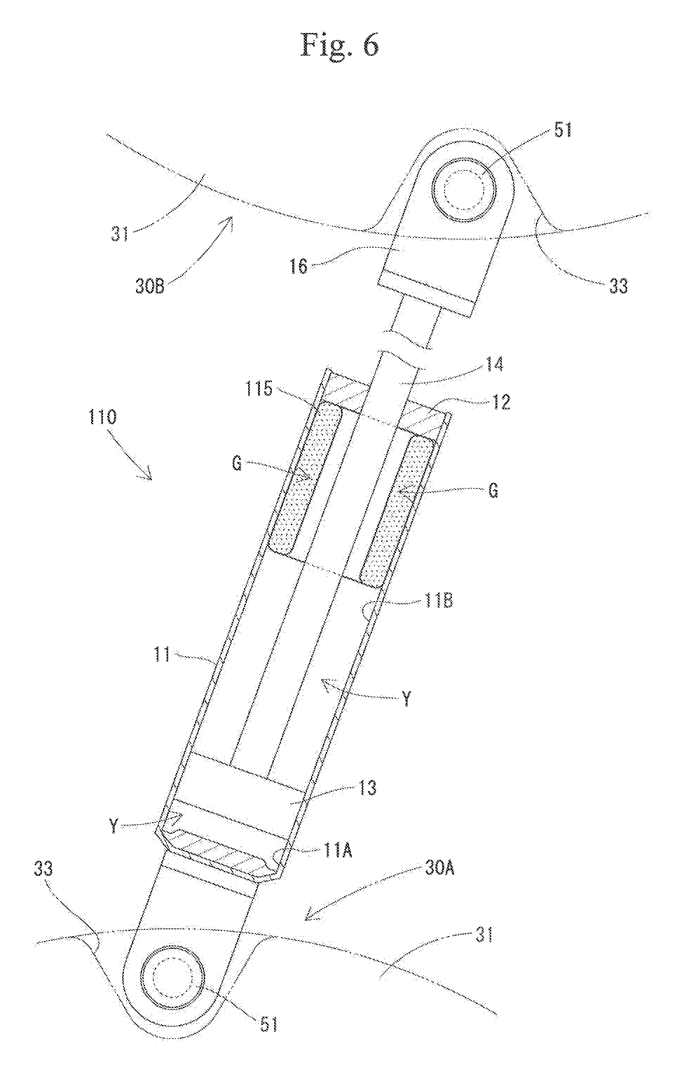

The overturn preventing device of a second embodiment differs from the first embodiment in the regulator provided in the damper 110 as illustrated in FIGS. 5 and 6. Identical or similar components in the second embodiment are labeled by the same reference symbols as those in the first embodiment, and detailed description of these parts will be eliminated.

The regulator of this overturn preventing device is a bag 115 which is columnar in outer shape and has a central hole extending around a central axis thereof in a direction of the central axis. A gas G is compressed and filled in the bag 115.

The bag 115 is elastically deformable while maintaining a length in the central axis direction. Since the bag 115 is filled with the gas G in a compressed state, one of end surfaces thereof closely contacts the rod guide 12 by a buoyant force and an outer peripheral surface thereof closely contacts an inner peripheral surface of the cylinder 11, with the rod 14 being inserted through the central hole. Thus, the overturn preventing device requires no time and effort to fix the bag 115 serving as the regulator in the rod-side pressure chamber 11B. The bag 115 serving as the regulator is disposed between the piston 13 and the rod guide 12 in the rod-side pressure chamber 11B.

When the damper 110 is contracted so that the piston 13 is moved to the counter-rod-side pressure chamber 11A side with the result that the hydraulic fluid Y in the counter-rod-side pressure chamber 11A flows into the rod-side pressure chamber 11B, the bag 115 serving as the regulator housed in the rod-side pressure chamber 11B is compressed thereby to be reduced in size while maintaining the length in the central axis direction of the rod 14, as illustrated in FIG. 6. Thus, the bag 115 is elastically deformed while maintaining its length in the central axis direction of the rod 14, following volume changes of the rod 14 in the cylinder 11, which changes are caused by extension/contraction of the damper 110. In this damper 110, an expansive force of the bag 115 is increased as the bag 115 is reduced, and the expansive force acts in the extension direction of the damper 110.

The overturn preventing device is mounted between the top surface of the furniture F and the ceiling C so that the bottom of the cylinder 11 is located lower than the opening, so that the rod 14 protrudes upward from the cylinder 11, and so that the central axes of the cylinder 11 and the rod 14 are inclined at the angle between 65° and 75° with respect to a horizontal plane. The bag 115 has the predetermined length along the central axis of the rod 14 and regulates the position of the piston 13 so that the piston 13 is immersed in the hydraulic fluid Y enclosed below the bag 115 filled with the compressed gas G in the state where the central axes of the cylinder 11 and the rod 14 are inclined at the angle between 65° and 75° with respect to the horizontal plane. In other words, when the piston 13 abuts against the bag 115 interposed between the piston 13 and the rod guide 12, further movement of the piston 13 to the rod guide 12 side is disallowed. Accordingly, the bag 115 serving as the regulator also functions as a stopper in the extending operation of the damper 110. Thus, in the damper 110, the bag 115 functions as the stopper and can suppress production of contact noise when the piston 13 abuts against the bag 115. Furthermore, since the piston 13 abuts against the bag 115, dust such as metal bits is prevented from being produced from the piston 13 into the hydraulic fluid Y. Furthermore, when the piston 13 is in abutment against the bag 115, the piston 13 is put in an immersed state in the hydraulic fluid Y. As a result, the damper 110 can exert a damping force with the movement of the piston 13 in the hydraulic fluid Y in the entire stroke range. Furthermore, since the gas is filled in the bag 115 in the compressed state thereby to be separated from the hydraulic fluid Y, the damper 110 can suppress production of bubbles due to the extending/contracting operation thereof.

As described above, the overturn preventing device is mounted between the top surface of the furniture F and the ceiling C with the piston 13 of the damper 110 being immersed in the hydraulic fluid Y. Accordingly, when the furniture is tilted by shaking of earthquake or the like, the damper 110 can exert a damping force in the entire stroke range so that the damping force of the damper 10 can always act on the furniture F, with the result that the furniture F can be prevented from overturn.

Accordingly, the overturn preventing device of the second embodiment can successfully prevent the furniture F from overturn.

Furthermore, in the damper in the second embodiment, the regulator is the bag 115 in which the gas G is filled in a compressed state and which is elastically deformable while maintaining its length in the central axis direction of the rod 14. As a result, the bag 115 is interposed between the piston 13 and the rod guide 12 in this damper, and when the piston 13 abuts against the bag 115, further movement of the piston 13 to the rod guide 12 side is disallowed. In other words, the bag 115 serving as the regulator regulates the position of the piston 13 while having the length such that the piston 13 is immersed in the hydraulic fluid Y. As a result, the damper 10 can exert a damping force with the movement of the piston 13 in the hydraulic fluid Y in the entire stroke range.

### Third Embodiment

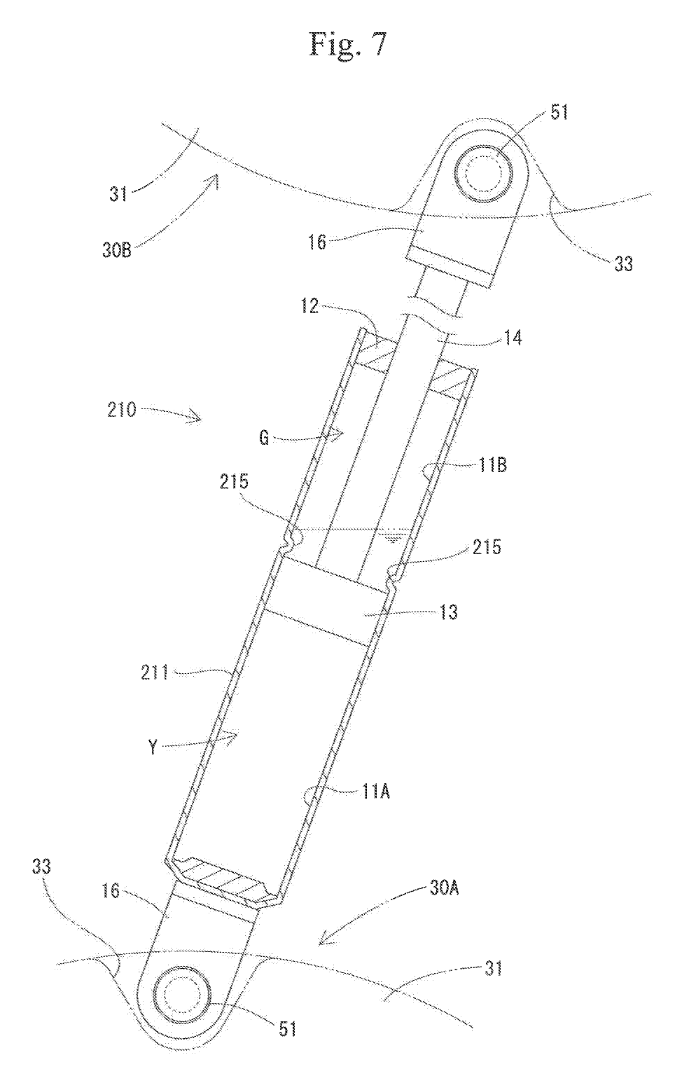

The overturn preventing device of a third embodiment differs from the first and second embodiments in the form of the regulator provided in the damper 210 as illustrated in FIG. 7 Identical or similar components in the third embodiment are labeled by the same reference symbols as those in the first and second embodiments, and detailed description of these parts will be eliminated.

The regulator of this overturn preventing device is a protrusion 215 protruding inward from an inner surface of the cylinder 211 located nearer to the rod guide 112 side than the housed piston 13. The protrusion 215 is formed by pressing a side surface of the cylinder 211 at a predetermined position from the outside toward the inside and protrudes so as to go around the inner peripheral surface of the cylinder 211 in the circumferential direction. Furthermore, an inner diameter of the part of the cylinder 211 in which part the protrusion 215 is formed is smaller than an outer diameter of the piston 13.

The overturn preventing device is mounted between the top surface of the furniture F and the ceiling C so that the bottom of the cylinder 211 is located lower than the opening, so that the rod 14 protrudes upward from the cylinder 211, and so that the central axes of the cylinder 211 and the rod 14 are inclined at the angle between 65° and 75° with respect to a horizontal plane. The protrusion 215 serving as the regulator is formed at the predetermined position in the cylinder 211 so that the piston 13 is immersed in the hydraulic fluid Y enclosed below the compressed gas G in the state where the central axes of the cylinder 211 and the rod 14 are inclined at the angle between 65° and 75° with respect to the horizontal plane, thereby regulating the position of the piston 13. In other words, when the outer peripheral edge of the piston 13 is locked to the protrusion 215, further movement of the piston 13 to the rod guide 12 side is disallowed. Furthermore, when the outer peripheral edge of the piston 13 is locked to the protrusion 215, the piston 13 is put in an immersed state in the hydraulic fluid Y. As a result, the damper 210 can exert a damping force with the movement of the piston 13 in the hydraulic fluid Y in the entire stroke range.

As described above, the overturn preventing device is mounted between the top surface of the furniture F and the ceiling C with the piston 13 of the damper 210 being immersed in the hydraulic fluid Y. Accordingly, when the furniture F is tilted by shaking of earthquake or the like, the damper 210 can exert a damping force in the entire stroke range so that the damping force of the damper 210 can always act on the furniture F, with the result that the furniture F can be prevented from overturn.

Accordingly, the overturn preventing device of the third embodiment can successfully prevent the furniture F from overturn.

Furthermore, in the damper 210 in the third embodiment, the regulator is the protrusion 215 which protrudes inward from the inner surface of the cylinder 211 located nearer to the rod guide 112 side than the piston 13 and to which the outer peripheral edge of the piston 13 is locked. As a result, in the damper 210, the piston 13 is not allowed to be moved to the rod guide 12 side beyond the protrusion 215 protruding inward from the inner surface of the cylinder 211. In other words, the protrusion 215 serving as the regulator is provided at such a position that the piston 13 is immersed in the operating liquid, thereby regulating the position of the piston 13. As a result, the damper 210 can exert a damping force with the movement of the piston 13 in the hydraulic fluid Y in the entire stroke range.

### Fourth Embodiment

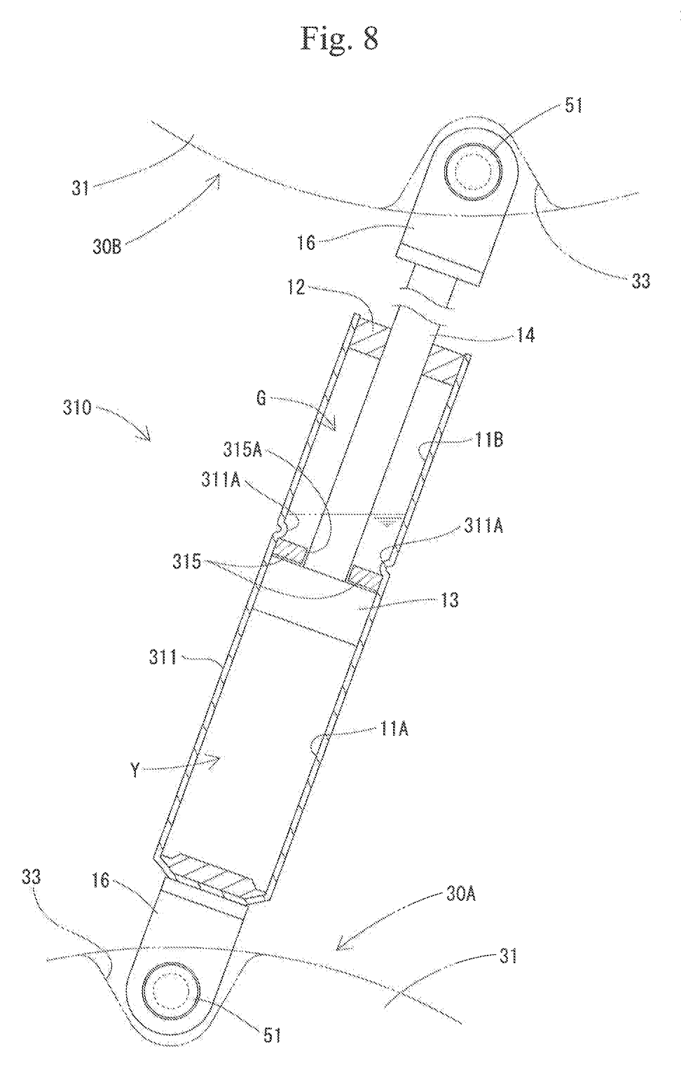

The overturn preventing device of a fourth embodiment differs from the first to third embodiments in the form of the regulator provided in the damper 310 as illustrated in FIG. 8. Identical or similar components in the fourth embodiment are labeled by the same reference symbols as those in the first to third embodiments, and detailed description of these parts will be eliminated.

The regulator of this overturn preventing device is an annular member which is fixed in the cylinder so as to be located nearer to the rod guide 12 side than the housed piston 13, and is formed with a insertion hole 315A at a center thereof through which the rod 14 is inserted. The annular member 315 has an outer diameter that is slightly smaller than an inner diameter of the cylinder 311. An outer peripheral edge of the annular member 315 is locked to a protrusion 311A which is formed by squeezing a side surface of the cylinder 311 at a predetermined position from the outside toward the inside and protrudes so as to go around the inner peripheral surface of the cylinder 311 in the circumferential direction, whereby the annular member 315 is fixed.

The overturn preventing device is mounted between the top surface of the furniture F and the ceiling C so that the bottom of the cylinder 311 is located lower than the opening, so that the rod 14 protrudes upward from the cylinder 311, and so that the central axes of the cylinder 311 and the rod 14 are inclined at the angle between 65° and 75° with respect to the horizontal plane. The annular member 315 serving as the regulator is fixed at the predetermined position in the cylinder 311 so that the piston 13 is immersed in the hydraulic fluid Y enclosed below the compressed gas G in the state where the central axes of the cylinder 311 and the rod 14 are inclined at the angle between 65° and 75° with respect to the horizontal plane, thereby regulating the position of the piston 13. In other words, when the piston 13 abuts against the annular member 315, further movement of the piston 13 to the rod guide 12 side is disallowed. Furthermore, when the piston 13 is in abutment against the annular member 315, the piston 13 is put in an immersed state in the hydraulic fluid Y. As a result, the damper 310 can exert a damping force with the movement of the piston 13 in the hydraulic fluid Y in the entire stroke range.

As described above, the overturn preventing device is mounted between the top surface of the furniture F and the ceiling C with the piston 13 of the damper 310 being immersed in the hydraulic fluid Y. Accordingly, when the furniture F is tilted by shaking of earthquake or the like, the damper 310 can exert a damping force in the entire stroke range so that the damping force of the damper 310 can always act on the furniture F, with the result that the furniture F can be prevented from overturn.

Accordingly, the overturn preventing device of the fourth embodiment can successfully prevent the furniture F from overturn.

Furthermore, in the damper 310 in the fourth embodiment, the regulator is the annular member 315 which is fixed in the cylinder 311 so as to be located nearer to the rod guide 12 side than the housed piston 13 and which is formed with the insertion hole 315A at the center through which the rod 14 is inserted.

As a result, in the damper 310, the piston 13 is not allowed to be moved to the rod guide 12 side beyond the annular member 315 fixed in the cylinder 311. In other words, the annular member 315 serving as the regulator is fixed at such a position that the piston 13 is immersed in the hydraulic fluid Y, thereby regulating the position of the piston 13. As a result, the damper 310 can exert a damping force with the movement of the piston 13 in the hydraulic fluid Y in the entire stroke range.

### Fifth Embodiment

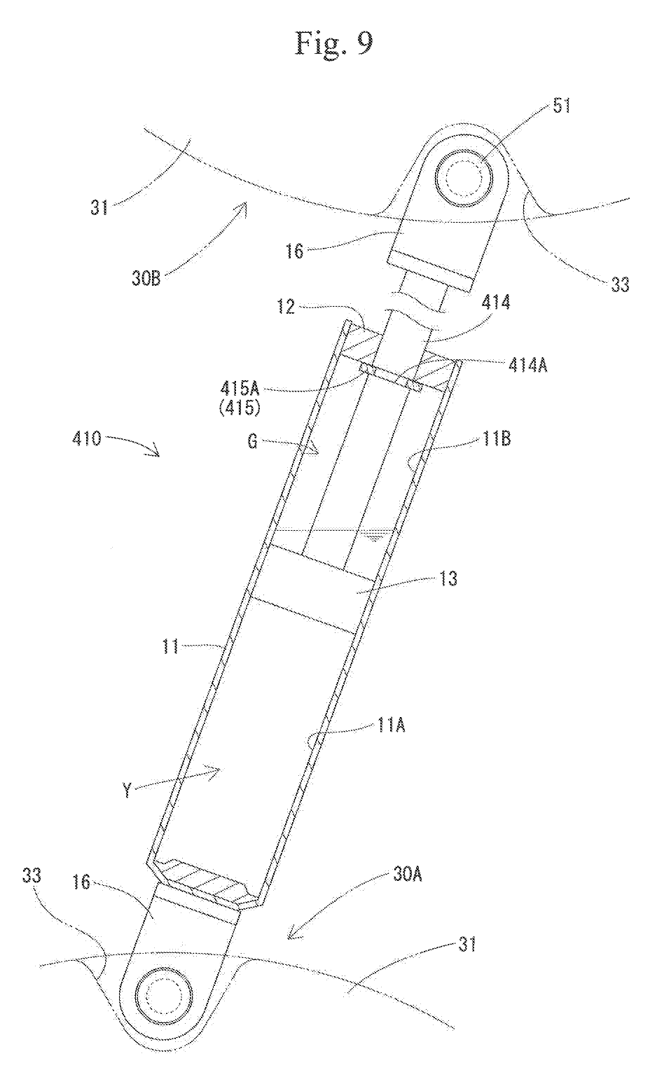

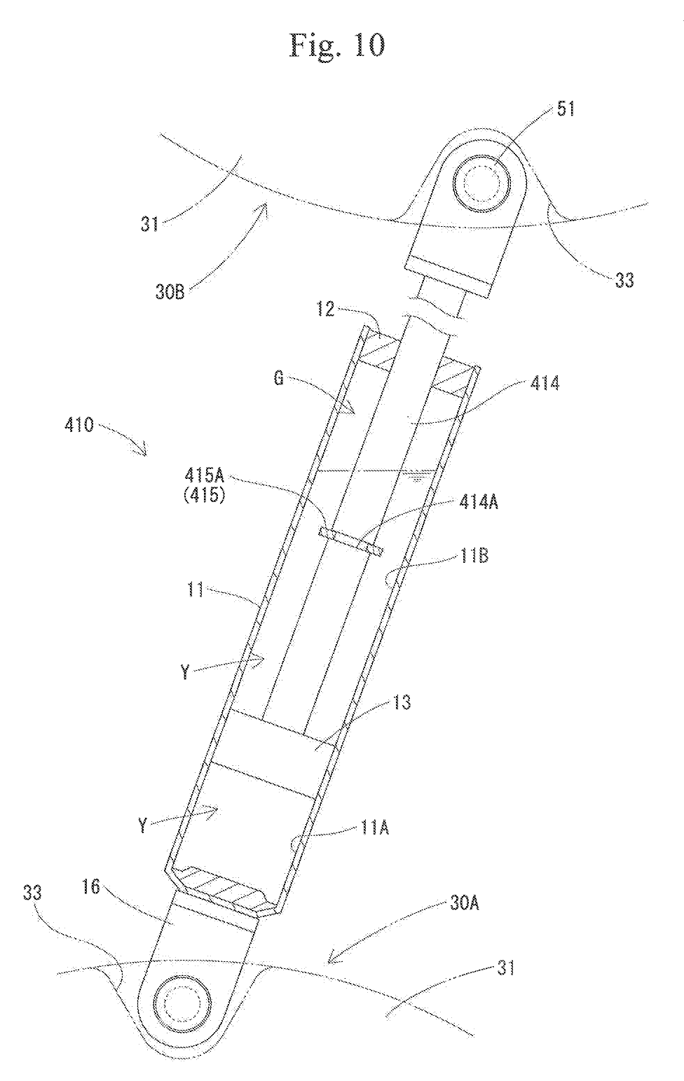

The overturn preventing device of a fifth embodiment differs from the first to fourth embodiments in the form of the regulator provided in the damper 410, as illustrated in FIGS. 9 and 10. Identical or similar components in the fifth embodiment are labeled by the same reference symbols as those in the first to fourth embodiments, and detailed description of these parts will be eliminated.

The regulator in the overturn preventing device is a flange 415 protruding outward from an outer peripheral surface of the rod 414. The flange 415 is to be locked to a lateral side of the rod guide 12 located at the piston 13 side. A groove 414A is formed to go around the outer peripheral surface of the rod 414 at a predetermined position in the central axis direction, and C-shaped washer 415A having a larger outer diameter than the rod 414 is fitted in the groove 414A, whereby the flange 415 is formed.

The overturn preventing device is mounted between the top surface of the furniture F and the ceiling C so that the bottom of the cylinder 11 is located lower than the opening, so that the rod 414 protrudes upward from the cylinder 11, and so that the central axes of the cylinder 11 and the rod 414 are inclined at the angle between 65° and 75° with respect to the horizontal plane. The flange 415 serving as the regulator is formed at the predetermined position on the rod 414 so that the piston 13 is immersed in the hydraulic fluid Y enclosed below the compressed gas G in the state where the central axes of the cylinder 11 and the rod 414 are inclined at the angle between 65° and 75° with respect to the horizontal plane, thereby regulating the position of the piston 13. In other words, when the flange 415 is locked to the lateral side of the rod guide 12 located at the piston 13 side, further movement of the piston 13 to the rod guide 12 side is disallowed, as illustrated in FIG. 9. Furthermore, when the flange 415 is locked to the lateral side of the rod guide 12 located at the piston 13 side, the piston 13 is put in an immersed state in the hydraulic fluid Y. As a result, the damper 410 can exert a damping force with the movement of the piston 13 in the hydraulic fluid Y in the entire stroke range.

As described above, the overturn preventing device is mounted between the top surface of the furniture F and the ceiling C with the piston 13 being immersed in the hydraulic fluid Y. Accordingly, when the furniture F is tilted by shaking of earthquake or the like, the damper 410 can exert a damping force in the entire stroke range so that the damping force of the damper 410 can always act on the furniture F, with the result that the furniture F can be prevented from overturn.

Accordingly, the overturn preventing device of the fifth embodiment can successfully prevent the furniture F from overturn.

In the damper 410 in the fifth embodiment, the regulator is the flange 415 which is to be locked to the lateral side of the rod guide 12 located at the piston 13 side. As a result, in the damper 410, when the flange 415 protruding outward from the outer peripheral surface of the rod 414 is locked to the lateral side of the rod guide 12 located at the piston 13 side, the piston 13 is not allowed to be moved to the rod guide 12 side. In other words, the flange 415 serving as the regulator is provided at such a position that the piston 13 is immersed in the hydraulic fluid Y, thereby regulating the position of the piston 13. As a result, the damper 410 can exert a damping force with the movement of the piston 13 in the hydraulic fluid Y in the entire stroke range.

The present invention should not be limited to the embodiments described above with reference to the drawings, but the technical scope of the invention encompasses the following embodiments, for example.
(1) Although the hydraulic fluid is enclosed in the cylinder in the first to fifth embodiments, not only the hydraulic fluid but any liquid may be enclosed in the cylinder.
(2) Although the cylindrical member or the bag each of which serves as the regulator is fixed in the cylinder in the first or second embodiment, but the cylindrical member or the bag may not be fixed as long as the cylindrical member or the bag is disposed between the piston and. the rod guide.
(3) Although the regulator is cylindrical in shape in the first embodiment, the regulator may have another shape such as a bar shape, as long as the regulator extends along the rod, is held between the piston and the rod guide and regulates the position of the piston.
(4) Although the bag serving as the regulator has a cylindrical outer shape and has the central hole in the second embodiment, the regulator may be a plurality of bags extending along the rod 14 between the piston and the rod guide.
(5) Although the protrusion serving as the regulator is formed by pressing the side surface of the cylinder from the outside toward the inside in the third embodiment, the protrusion may be formed in another manner.
(6) Although the protrusion serving as the regulator is caused to protrude so as to go around the inner peripheral surface of the cylinder in the circumferential direction in the third embodiment, protrusions may be formed at intervals on the same circumferential surface.
(7) Although the annular member serving as the regulator is locked to the protrusion going around the inner peripheral surface of the cylinder in the circumferential direction, thereby to be fixed in the fourth embodiment, the annular member maybe fixed in the cylinder without providing the protrusion.
(8) Although the flange serving as the regulator is formed by forming the groove in the rod guide and fitting the C-shaped washer into the groove in the fifth embodiment, the flange may be formed in another manner.
(9) Although the compressed gas is enclosed in the cylinder in the first and third to fifth embodiments, an uncompressed gas may be enclosed in the cylinder. EXPLANATION OF REFERENCE SYMBOLS

10, 110, 210, 301, 410 . . . damper; 11, 211, 311 . . . cylinder; 11A . . . counter-rod-side pressure chamber; 11B . . . rod-side pressure chamber; 12 . . . rod guide; 13 . . . piston; 14, 414 . . . rod; 15, 115, 215, 315, 415 . . . regulator (15 . . . cylindrical member, 115 . . . bag, 215 . . . protrusion, 315 . . . annular member, 415 . . . flange); C . . . ceiling; F . . . furniture (article); G . . . gas (compressed gas); and Y . . . hydraulic fluid (operating liquid).

1. A damper comprising:
a bottomed cylindrical cylinder having an opening;
a rod guide closing the opening of the cylinder;
a piston slidably housed in the cylinder; and
a rod having a proximal end coupled to the piston and slidably inserted through the rod guide, so that a distal end side of the rod protrudes out of the cylinder,
wherein an operating liquid and a gas are enclosed in the cylinder,
the damper further comprising a regulator which regulates a position of the piston so that the piston is immersed in the operating liquid enclosed below the gas in the cylinder in a state where a bottom of the cylinder is located lower than the opening and the rod protrudes upward from the cylinder and where central axes of the cylinder and the rod are inclined at a predetermined angle with respect to a horizontal plane.

2. The damper according to claim 1, wherein the cylinder has an interior divided by the piston into a rod-side pressure chamber in which the proximal end of the rod is housed and a counter-rod-side pressure chamber, and the regulator is disposed between the piston and the rod guide in the rod-side pressure chamber and has a predetermined length along a central axis of the rod.

3. The damper according to claim 2, wherein the regulator is a bag in which is a gas is filled in a compressed state and which is elastically deformable while maintaining a length thereof in a direction of the central axis of the rod.

4. The damper according to claim 1, wherein the regulator is a protrusion which protrudes inward from an inner surface of the cylinder located nearer to the rod guide side than the piston and to which an outer peripheral edge of the piston is locked.

5. The damper according to claim 1, wherein the regulator is an annular member which is fixed in the cylinder to be located nearer to the rod guide side than the piston and has an insertion hole formed in a center thereof through which the rod is inserted.

6. The damper according to claim 1, wherein the regulator is a flange which protrudes outward from an outer peripheral surface of the rod and is locked to a lateral face of the rod guide at the piston side.

7. An overturn preventing device comprising the damper specified in claim 1 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.

8. An overturn preventing device comprising the damper specified in claim 2 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.

9. An overturn preventing device comprising the damper specified in claim 3 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.

10. An overturn preventing device comprising the damper specified in claim 4 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.

11. An overturn preventing device comprising the damper specified in claim 5 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.

12. An overturn preventing device comprising the damper specified in claim 6 which is to be mounted between a ceiling and a top surface of an article installed on an installation surface, in the state where the bottom of the cylinder is located lower than the opening and the rod protrudes upward from the cylinder and where central axes of the cylinder and the rod are inclined at the predetermined angle with respect to the horizontal plane.
